(19) United States
(12) Patent Application Publication
(10) Pub. No.: US 2025/0207755 A1
(43) Pub. Date: Jun. 26, 2025

(54) Low-glare lighting device having hidden light source

(71) Applicant: PSLab Holding Limited, London (GB)

(72) Inventor: Dimitri El Saddi, Beirut (LB)

(21) Appl. No.: 18/989,056

(22) Filed: Dec. 20, 2024

(30) Foreign Application Priority Data
Dec. 21, 2023 (DE) 10 2023 136 232.1

(51) Int. Cl. F21V 3/04; F21V 19/02

(52) U.S. Cl. CPC F21V 3/049; F21V 19/02

(57) ABSTRACT

A device for the low-glare lighting of a room is disclosed. The device has: a translucent body; a first lighting unit arranged on or in the translucent body, which first lighting unit is adapted to light a surface; and a second lighting unit arranged in the translucent body, which second lighting unit is adapted to light the room through the translucent body.

There are presented herein a device and a method for the low-glare lighting and/or illumination of a room and of a surface.

When lights, for example ceiling spotlights, illuminate a room, an observer standing in the illuminated room is often dazzled by the ceiling spotlights themselves. This is because the light emitted by the ceiling spotlight is projected via the walls of the room to the observer, who thus perceives a room luminance. In addition, the observer perceives a ceiling spotlight luminance of the ceiling spotlights. If the ceiling spotlight luminance exceeds the room luminance perceived by the observer, the observer is dazzled by the ceiling spotlight. This effect already occurs if the observer perceives the actual ceiling light peripherally, or out of the corner of his eye. The room illumination is perceived as being less pleasant. This is important in particular in environments in which an illuminated atmosphere that is pleasant for the observer is necessary. Generally speaking, wherever light is required for the recognition of an object by a user. Examples which may be mentioned here include workstations in open-plan offices, workstations of draftspersons, or exhibition spaces for pieces of art in museums, or reading corners for reading newspapers.

There is a need for a device for low-glare lighting.

To that end, a device as claimed in claim 1 and a method as claimed in claim 19 are proposed.

According to a first aspect, a device for the low-glare lighting of a room is proposed. The device has a translucent body. The device has a first lighting unit. The first lighting unit is arranged on or in the translucent body. The first lighting unit is adapted to light a surface, in particular directly. The device has a second lighting unit. The second lighting unit is adapted to light the room through the translucent body.

The device has the advantage, for example, that the room is illuminated with soft, pleasant, indirect light by the illumination of areas of the room (e.g. the ceiling or wall). In addition or at the same time, a surface, for example a work space, is lit with second light. An observer is barely dazzled by the actual, for example hidden, light source. The observer is given the impression that only a single light source is being used to light the room and the surface. In addition, the device has at least almost no annoying glare phenomena in particular for an outside observer. Any glare phenomena fade into the background compared to the luminance of the room when the device is used to light the room and the surface.

The first lighting unit can have a first hidden light source. The device can be devoid of a line of sight between an observer who is in the room and the first hidden light source.

The device can have a longitudinal axis and a transverse axis. The translucent body can have a first opening in particular arranged along the longitudinal axis and extending along the transverse axis. The first lighting unit can be configured as a hidden or concealed lighting unit or can have a hidden or concealed lighting unit. For example, the first lighting unit can have a first light source that is hidden from an observer who is in the room. The first lighting unit can be adapted to emit first, for example concentrated, light. The first lighting unit can be configured to light a surface via the first opening, in particular only via the first opening.

The second lighting unit can be adapted to emit second light. The second lighting unit can be configured to light the room through the translucent body, in particular only through the translucent body.

The translucent body can have at least one further opening, in particular arranged/extending along the longitudinal axis and/or extending/arranged along the transverse axis. The device can have at least one further lighting unit. The at least one further lighting unit can be arranged in the translucent body. The at least one further lighting unit can be adapted to emit third light. The at least one further lighting unit can be adapted to light a further surface via the at least one further opening, in particular only via the at least one further opening. The at least one further lighting unit can have a second light source that is hidden from an observer who is in the room.

A surface can be understood as being the surfaces of walls, the ceiling or the floor of the room and/or surfaces of objects in the room.

The first and/or second hidden light source can be configured as at least one light-emitting diode.

There can be a line of sight between the observer and the first and/or second, for example hidden, light source for a first observation angle. The first observation angle can have a value between ±90°, in particular between ±60° or ±40°, with respect to the longitudinal axis.

The device can be devoid of a line of sight between an observer who is in the room and the first and/or second hidden light source. In other words, the device can be arranged in a room such that there is/are no line(s) of sight between an observer who is in the room and the first and/or second hidden light source.

The device can have a device luminance. The translucent body can have a body luminance. The room can have a room luminance. A luminance ratio of the device luminance or body luminance to a room luminance can be less than or equal to one. The luminance ratio can be determined in relation to an observer who is standing outside the first and/or second observation angle. A luminance ratio of the device luminance or body luminance to a mean luminance of an area (apart from the surface that is lit via the first and/or the further opening), in particular of a wall or ceiling, or of part (apart from the surface that is lit via the first and/or the further opening), in particular a circular part with a radius of 1, 2 or 3 m, of an area of the room, can be less than or equal to one.

The first and/or the at least one further opening can be arranged along, in particular on, the longitudinal axis. The first and the at least one further opening can be arranged in particular opposite one another.

The first lighting unit and the translucent body can be arranged on the longitudinal axis. A light-emitting end of the first lighting unit can terminate at, in particular flush with, the first opening of the translucent body. The at least one further lighting unit and the translucent body can be arranged on the longitudinal axis. A light-emitting end of the at least one further lighting unit can terminate at, in particular flush with, the at least one further opening.

The first and/or the at least one further opening can each have a light emission angle. The light emission angle(s) can have a value between ±90°, in particular ±60° or ±40°, at the first and/or the at least one further opening with respect to a perpendicular to the respective opening plane.

The first observation angle can correspond to the light emission angle.

There can be a line of sight between the observer and the first and/or second, for example hidden, light source for a first observation angle, which is smaller than the light emission angle(s).

The first lighting unit and the at least one further lighting unit can be capable of being connected, in particular screwed, together. The second lighting unit can be arranged on the first and/or the at least one further lighting unit, in particular connected/fastened with/to the first and/or at least one further lighting unit.

The device can have a longitudinal axis and a transverse axis. The device can have a translucent body. The device can have a second lighting unit. The second lighting unit can be arranged in the translucent body. The second lighting unit can be adapted to emit second light. The second lighting unit can be adapted to light the room through the translucent body, in particular only through the translucent body. The device can have a pedestal unit. The pedestal unit or the device together with the pedestal unit can be in contact with a surface. The pedestal unit can be adapted to generate first light. The pedestal unit can be adapted to conduct the first light out of the pedestal unit. The pedestal unit can be adapted to project the first light onto part of the surface surrounding the pedestal unit or the device together with the pedestal unit. The translucent body can be arranged on the pedestal unit. The translucent body can be arranged at/on the pedestal unit or can be connected by an underside (of the translucent body) to an upper side of the pedestal unit.

The device can have a device luminance. The translucent body can have a body luminance. The room can have a room luminance. A luminance ratio of the device luminance or body luminance to a room luminance can be less than (or equal to) one. A luminance ratio of the device luminance or body luminance to a mean room luminance of an area (apart from the surface onto which the first light is projected), in particular of a wall or ceiling, or of part (apart from the surface onto which the first light is projected), in particular a circular part with a radius of 1, 2 or 3 m, of an area of the room, can be less than or equal to one.

The pedestal unit can have a pedestal body. The pedestal body can be in contact with the surface. The pedestal body can be adapted to conduct light, in particular first light. A first lighting unit can be arranged in the pedestal body. The first lighting unit can be adapted to emit first light.

The device can have a light-guiding unit. The light-guiding unit can have a first lighting unit. The light-guiding unit can be arranged at or on the pedestal body. An underside of the light-guiding unit can be connected to an upper side of the pedestal body. An underside of the translucent body can be connected to an upper side of the light-guiding unit.

The light-guiding unit can be adapted to receive the first light emitted by the first lighting unit. The light-guiding unit can be adapted to conduct the first light out of the light-guiding unit. The light-guiding unit can be adapted to project the first light onto the part of the surface surrounding the device/pedestal unit/pedestal body.

The light-guiding unit can be arranged along the longitudinal axis between the translucent body and the pedestal body.

The light-guiding unit can be adapted to project the first light, in particular onto the part of the surface surrounding the device/pedestal unit/pedestal body, at an angle between ±90°, in particular ±60° or ±0°, with respect to the longitudinal axis.

The light-guiding unit can have a light conductor, in particular a planar light conductor. The light conductor can have a first lighting unit. The, in particular planar, light conductor can be adapted to receive the first light and to conduct it to a deflection mirror, in particular a curved deflection mirror. The light conductor can have a surface that is smooth, in particular polished or high-gloss. The light conductor can comprise or consist of high-transparency material, in particular glass or polymethyl methacrylate (PMMA).

The deflection mirror can be adapted to project the first light, which in particular is received from the light conductor, onto the part of the surface surrounding the device/pedestal unit/pedestal body at an angle having a value between ±90°, in particular ±60° or ±45°, with respect to the longitudinal axis.

The deflection mirror can be adapted to project the first light, which in particular is received from the light conductor, onto the part of the surface surrounding the device/pedestal unit/pedestal body at an angle having a value of greater than ±45°, in particular ±60° or ±90°, with respect to the longitudinal axis.

According to a second aspect, a method for the low-glare illumination of a room is proposed. The method comprises providing a translucent body. The method further comprises providing a first lighting unit arranged on/in the translucent body. The method further comprises lighting a surface by means of the first lighting unit. The method comprises providing a second lighting unit arranged in the translucent body. The second lighting unit is adapted to emit second light. The method comprises lighting the room with the second light through the translucent body.

Further features, properties, advantages and possible modifications will become clear to a person skilled in the art from the following descriptions, in which reference is made to the accompanying drawings.

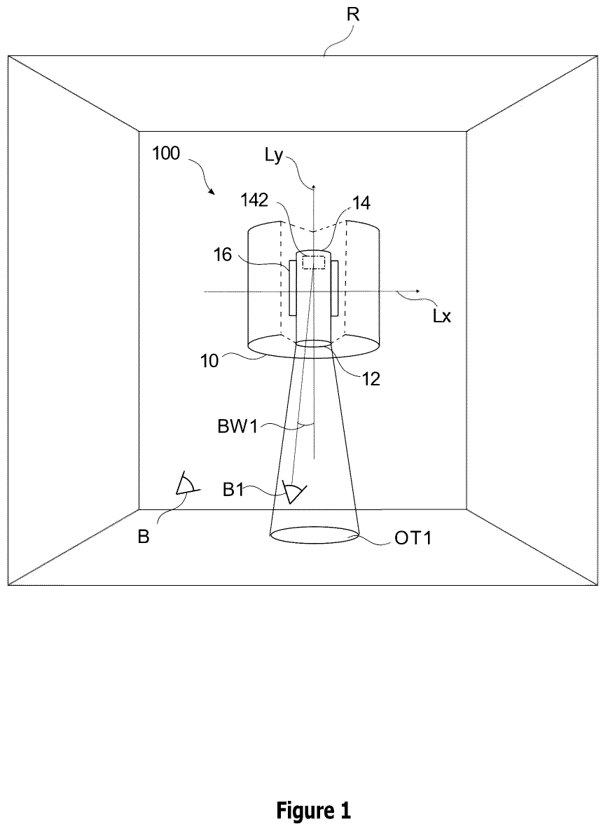

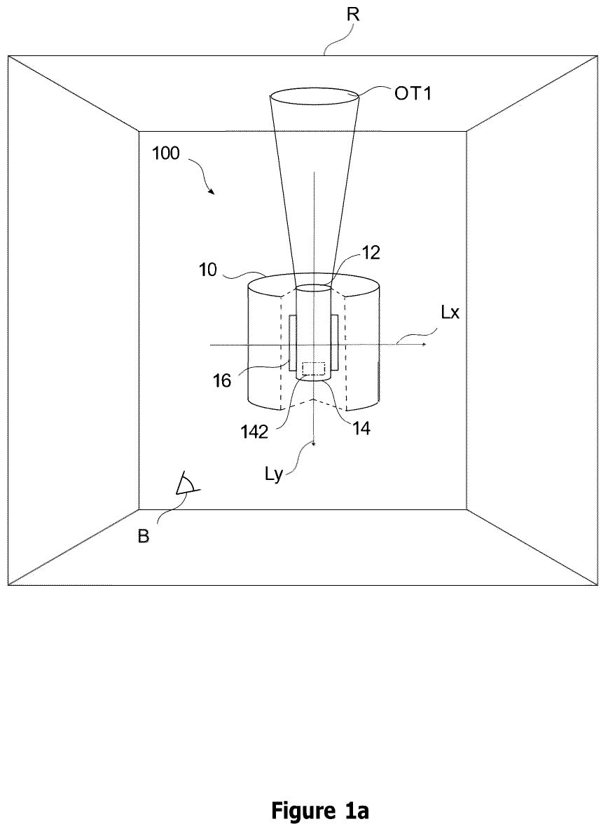

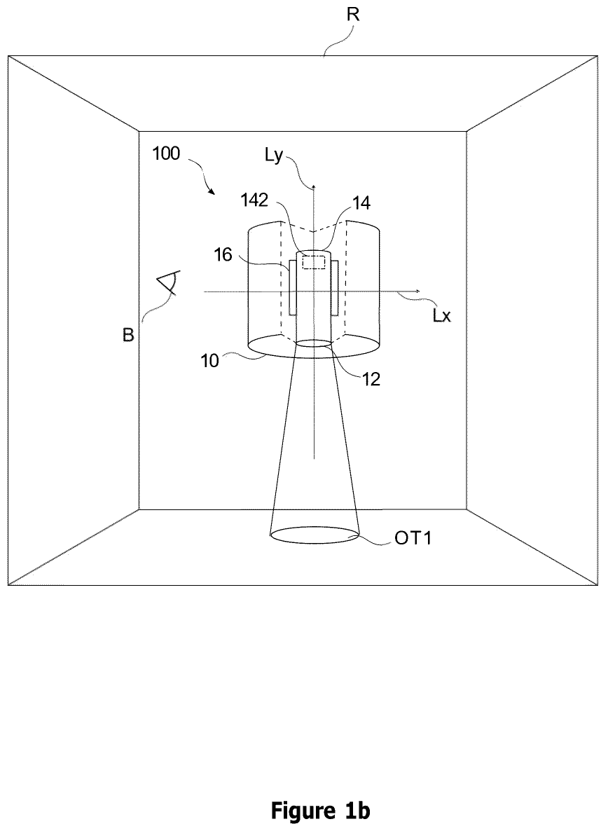

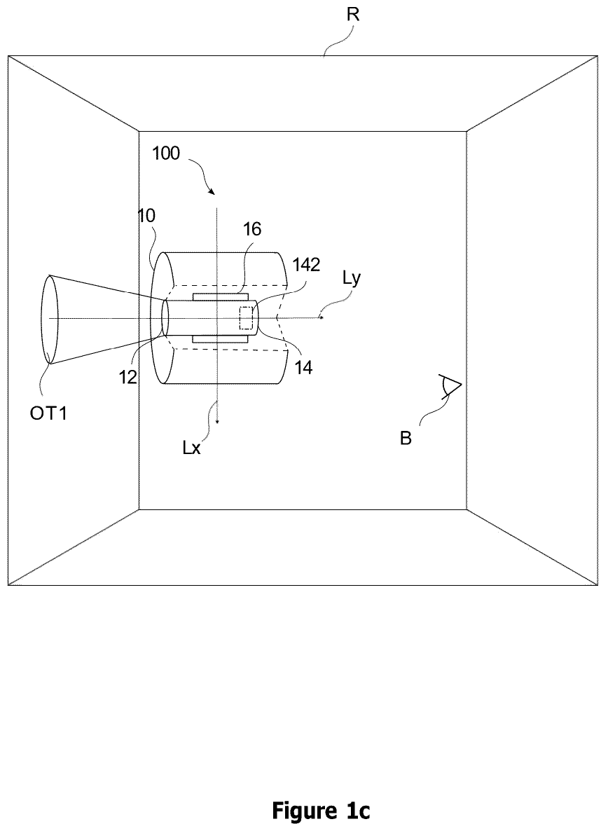

FIG. 1 shows an example of a lighting device for lighting a room.

FIG. 1a shows an example of a ceiling installation position of the lighting device for lighting a room.

FIG. 1b shows a further example of a floor installation position of the lighting device for lighting on a floor of a room.

FIG. 1c shows a further example of a wall installation position of the lighting device for lighting a room.

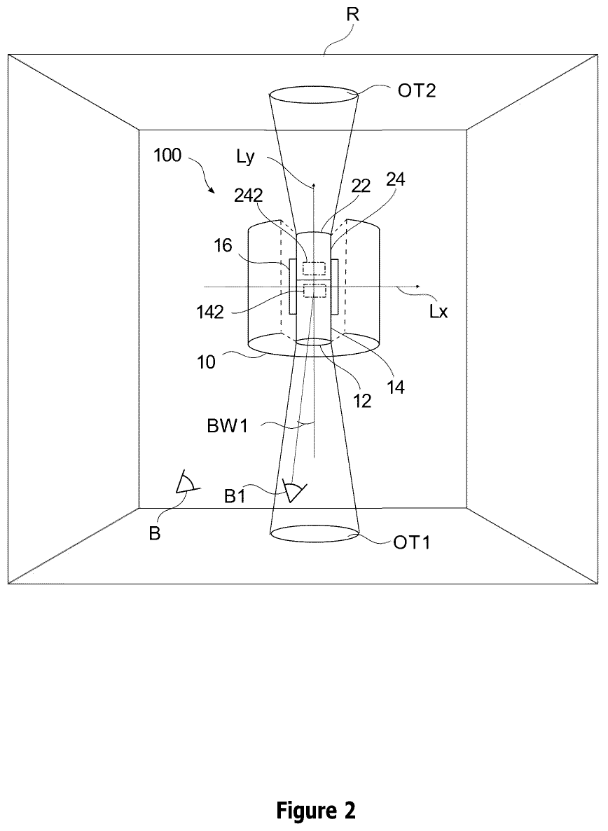

FIG. 2 shows an example of a lighting device having two lighting units.

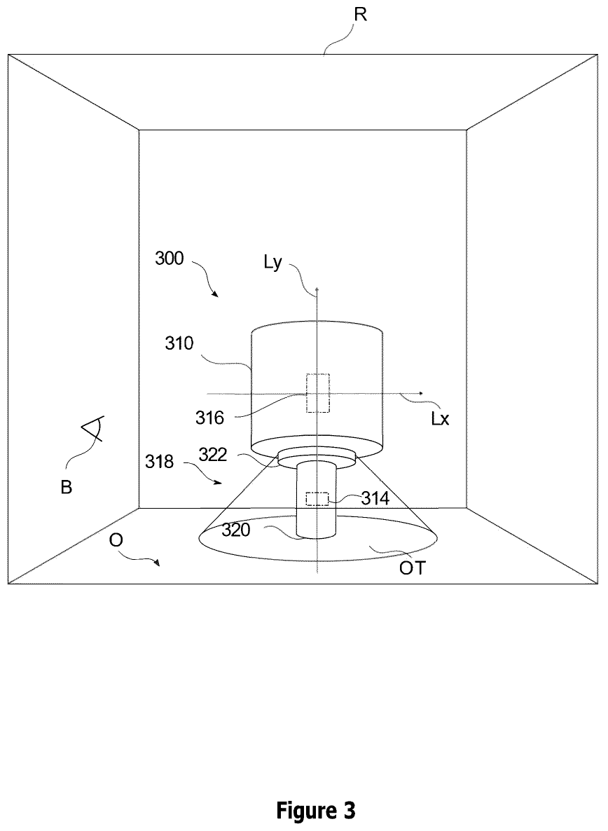

FIG. 3 shows an example of a lighting device.

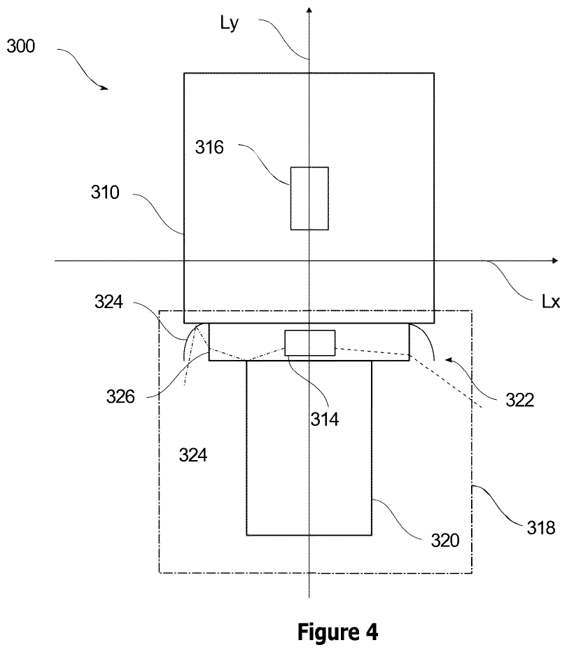

FIG. 4 shows an example of a lighting device with a corresponding beam path.

FIG. 1 shows an example of an embodiment variant of the device for low-glare lighting. In the representation, the device 100 has a translucent body 10, which in turn has a first opening 12. In the representation, a segment of the translucent body 10 is not shown in order to allow the interior thereof to be seen. The device 100 further has a first lighting unit 14, which is arranged in the translucent body 10 and emits first light. The first light is projected only via the first opening 12 onto a surface OT1. In addition to the first lighting unit 14, a second lighting unit 16 is arranged in the translucent body 10. In the example shown, the second lighting unit 16 is connected to the first lighting unit 14 and emits second light. An inner side of the translucent body 10 is illuminated with the second light of the second lighting unit 16. The second light passes only through the translucent body 10 and lights/illuminates the room R. In the example shown, the first lighting unit 14 has in its interior a hidden light source 142, which an observer B standing outside the device 100 sees only when the observation angle is less than a specific observation angle BW1 (observer B1). In the present case, the observer B1 is able to see the light source 142 only when BW1 is within ±35°. Outside this observation angle range (±35° relative to the longitudinal axis Ly), the observer B1 does not see the light source 142. The maximum light emission angle in the present example is ±35°.

FIG. 1a shows an example of a ceiling installation position of the device 100 for low-glare lighting in a room. In the representation, the device 100, which is mounted on a ceiling, has a translucent body 10, which in turn has a first opening 12. In the representation, a segment of the translucent body 10 is not shown in order to allow the interior thereof to be seen. The device 100 further has a first lighting unit 14, which is arranged in the translucent body 10 and emits first light. The first light is projected only via the first opening 12 onto a surface OT1 of the ceiling. In addition to the first lighting unit 14, a second lighting unit 16 is arranged in the translucent body 10. In the example shown, the second lighting unit 16 is connected to the first lighting unit 14 and emits second light. An inner side of the translucent body 10 is illuminated with the second light of the second lighting unit 16. The second light passes only through the translucent body 10 and lights/illuminates the room R. In the example shown, the first lighting unit 14 has in its interior a hidden light source 142. Because the device 100 is mounted on the ceiling of a room R, an observer B standing beneath it on the floor of the room cannot see the hidden light source 142. In other words, the device 100 has been installed above the eye level of an observer of average height. In addition to the illumination of the room R and the lit part of the ceiling, the observer B perceives a glow of the translucent body 10. In the present case, the observer B would only be able to see the hidden light source if he were to stand on a ladder and look directly into the first opening 12.

FIG. 1b shows an example of a floor installation position of the device 100 for low-glare lighting in a room. In the representation, the device 100, which is mounted on a floor of the room, has a translucent body 10, which in turn has a first opening 12. In the representation, a segment of the translucent body 10 is not shown in order to allow the interior thereof to be seen. The device 100 further has a first lighting unit 14, which is arranged in the translucent body 10 and emits first light. The first light is projected only via the first opening 12 onto a surface OT1 of the floor. In addition to the first lighting unit 14, a second lighting unit 16 is arranged in the translucent body 10. In the example shown, the second lighting unit 16 is connected to the first lighting unit 14 and emits second light. An inner side of the translucent body 10 is illuminated with the second light of the second lighting unit 16. The second light passes only through the translucent body 10 and lights/illuminates the room R. In the example shown, the first lighting unit 14 has in its interior a hidden light source 142. Because the device 100 is mounted on the floor of the room, an observer B standing next to the device 100 cannot see the hidden light source 142. In other words, the device 100 has been installed beneath the eye level of an observer B of average height. In addition to the illumination of the room and the lit part of the floor, the observer B perceives a glow of the translucent body. In the present case, the observer B would only be able to see the hidden light source 142 if he were to lie on the floor, beneath the device, and look directly into the first opening 12.

FIG. 1c shows an example of a wall installation position of the device 100 for low-glare lighting in a room. In the representation, the device 100, which is mounted on a wall of the room, has a translucent body 10, which in turn has a first opening 12. In the representation, a segment of the translucent body 10 is not shown in order to allow the interior thereof to be seen. The device 100 further has a first lighting unit 14, which is arranged in the translucent body 10 and emits first light. The first light is projected only via the first opening 12 onto a surface OT1 of the wall. In addition to the first lighting unit 14, a second lighting unit 16 is arranged in the translucent body 10. In the example shown, the second lighting unit 16 is connected to the first lighting unit 14 and emits second light. An inner side of the translucent body 10 is illuminated with the second light of the second lighting unit 16. The second light passes only through the translucent body 10 and lights/illuminates the room R. In the example shown, the first lighting unit 14 has in its interior a hidden light source 142. Because the device 100 is mounted on the wall of the room R, an observer B standing next to the device 100 cannot see the hidden light source 142. In other words, the device 100 has been installed at the eye level of an observer B of average height. In addition to the illumination of the room R and the lit part of the wall, the observer B perceives a glow of the translucent body 10. In the present case, the observer B would only be able to see the hidden light source 142 if he were to lean against a wall, while standing between the wall and the device 100, and look directly into the first opening 12.

FIG. 2 shows an example of an embodiment variant in which the translucent body 10 has a further opening 22. In the representation, the device 100 has a translucent body 10, which in turn has a first opening 12 and a further opening 22. In the representation, a segment of the translucent body is not shown in order to allow the interior thereof to be seen. The device has a first and a further lighting unit 14, 24, which are arranged in the translucent body 10 and emit first light and third light. The first light is projected only via the first opening 12 onto a surface OT1. The third light is projected only via the further opening 22 onto a further surface OT2. In addition to the first and the further lighting unit 14, 24, a second lighting unit 16 is arranged in the translucent body.

In the example shown, the second lighting unit 16 is arranged on the first and second lighting unit 14 and emits second light. An inner side of the translucent body 10 is illuminated with the second light. The second light passes only through the translucent body 10 and lights/illuminates the room R. In the example shown, the first and the further lighting unit 14, 24 each have a hidden light source 142, 242 in their interior. In the present example, the device is devoid of a line of sight between the observer and the hidden light sources 142, 242. To that end, the device 100 is in the present example mounted on a ceiling, wherein the surface OT2 is part of the ceiling. An observer B standing beneath it cannot see the hidden light source 242. If the device is mounted on a ceiling with the second opening at the front, a ring light can alternatively be arranged in place of the lighting unit 24, since a view of the device mounted on the ceiling is usually denied to an observer. The lighting unit 14, on the other hand, has in its interior, between the hidden light source 142 and the first opening 12, optical elements which guide the first light from the hidden light source 142 to the first opening but block the observer's view of said light source. The path between the observer B and the hidden light source is devoid of a line of sight.

FIG. 3 shows an example of an embodiment variant. The example has a translucent body 310, in which a second lighting unit 316 is arranged. The second lighting unit 316 emits second light, which illuminates/lights the room R through the translucent body 310. Owing to the translucent property, the room is bathed in soft and warm light. The translucent body 310 is arranged on and connected to a light-guiding unit 322. The light-guiding unit 322 is in turn arranged on and connected to a pedestal body 320. The pedestal body 320 has in its interior a first lighting unit 314. The lighting unit 314 is arranged in the pedestal body 320 and emits first light. The first light is transmitted inside the pedestal body 320 to the light-guiding unit 322, which in turn receives the first light and guides it along the transverse axis Lx to the (own) edge of the light-guiding unit 322. From here, the first light is projected out of the light-guiding unit 322 onto part OT of the surface O with which the device is in contact via the pedestal body 320. In the present representation, the device is designed as a desk/reading lamp. The room is therefore illuminated via the translucent body 310 and a book or the like can be placed in the region that is lit by the first lighting unit 314. A light atmosphere that is pleasant for reading is thus created for the reader, since he is not dazzled by the hidden lighting units 314.

FIG. 4 shows a detailed representation of the example of FIG. 3, in which the beam path from the lighting unit 314 out of the light-guiding unit 322 is visualized. In the example shown, the light-guiding unit 322 has in the interior thereof the first lighting unit 314, which emits first light in the direction towards the light-guiding unit 322. In the variant shown, the light-guiding unit 322 has a planar light conductor 326 and a deflection mirror 324. The planar waveguide 326 conducts the first light only to the edge/ends of the planar waveguide 326. The translucent body 10 arranged on the planar waveguide 326 receives only the second light from the second lighting unit 316. An upper side of the planar waveguide 326 is adapted to prevent 10 propagation of the conducted/guided first light into the translucent body.

From the edge/ends of the planar waveguide 326, the first light is projected via the deflection mirror 324 onto the part of the surface. An observer is devoid of a line of sight between himself and the lighting unit 314 arranged in the first lighting source.

1. A device for the low-glare lighting of a room, having:
a translucent body,
a first lighting unit arranged on or in the translucent body, which first lighting unit is adapted to light a surface, in particular directly,
a second lighting unit arranged in the translucent body, which second lighting unit is adapted to light the room through the translucent body.

2. The device as claimed in claim 1, wherein the first lighting unit has a first hidden light source and the device is devoid of a line of sight between an observer who is in the room and the first hidden light source.

3. The device as claimed in claim 1, further having a longitudinal axis and a transverse axis, wherein:
the translucent body further has a first opening arranged along the longitudinal axis and extending along the transverse axis,
the first lighting unit arranged in the translucent body is adapted to emit first light via the first opening and to light a surface, and
the second lighting unit arranged in the translucent body is adapted to emit second light and to light the room through the translucent body, wherein the first lighting unit has a first light source that is hidden from an observer who is in the room.

4. The device as claimed in claim 3, wherein the translucent body has at least one further opening, in particular arranged/extending along the longitudinal axis and/or arranged/extending along the transverse axis, wherein there is arranged on or in the translucent body at least one further lighting unit which is adapted to emit third light and to light a further surface via the at least one further opening, wherein the at least one further lighting unit has a second light source that is hidden from an observer who is in the room.

5. The device as claimed in claim 3,
wherein there is a line of sight between the observer and the first and/or second hidden light source, wherein a first observation angle has a value between ±90°, in particular between ±60° or ±40°, with respect to the longitudinal axis.

6. The device as claimed in claim 3, wherein the device is devoid of a line of sight between an observer who is in the room and the first and/or second hidden light source.

7. The device as claimed in claim 1, wherein a luminance ratio of a device luminance to a mean room luminance of an area or part of a/the area of the room is less than one, wherein the luminance ratio is determined in relation to an observer who is standing outside a first and/or second observation angle.

8. The device as claimed in claim 1, wherein a luminance ratio of a device luminance to a room luminance is less than one.

9. The device as claimed in claim 1, wherein the first and the at least one further opening are arranged along, in particular on, the longitudinal axis, in particular opposite one another.

10. The device as claimed in claim 3, wherein the first lighting unit and the translucent body are arranged on the longitudinal axis and a light-emitting end of the first lighting unit terminates at, in particular flush with, the first opening of the translucent body, and/or the at least one further lighting unit and the translucent body are arranged on the longitudinal axis and a light-emitting end of the further lighting unit terminates at, in particular flush with, the at least one further opening.

11. The device as claimed in claim 1, wherein a light emission angle at the first and/or the at least one further opening has a value between ±90°, in particular ±60° or ±40°, with respect to a perpendicular to the respective opening plane.

12. The device as claimed in claim 1, wherein the first lighting unit and the further lighting unit can be screwed together and/or the second lighting unit is arranged on the first and/or on the further lighting unit, in particular is connected to the first and/or the further lighting unit.

13. The device as claimed in claim 1, further having:
a longitudinal axis and a transverse axis,
a second lighting unit arranged in the translucent body, which second lighting unit is adapted to emit second light and to light the room through the translucent body, and
a pedestal unit in contact with a surface, which pedestal unit is adapted to generate first light, to conduct it out of the pedestal unit and to project it onto part of the surface surrounding the pedestal unit.

14. The device as claimed in claim 13, wherein a luminance ratio of a device luminance to a mean room luminance of an area or a mean room luminance of part of a/the area of the room is less than one.

15. The device as claimed in claim 14, wherein a luminance ratio of a device luminance to a mean room luminance of an area or a mean room luminance of part of a/the area of the room is less than or equal to one, wherein the luminance ratio is determined in relation to an observer who is standing outside the part of the surface surrounding the pedestal unit.

16. The device as claimed in claim 13, wherein the pedestal unit has:
a pedestal body in contact with the surface, in which pedestal body there is arranged, in particular centrally in a light-guiding unit and/or light conductor which has the pedestal body, a first lighting unit which is adapted to emit first light, and
a light-guiding unit arranged at or on the pedestal body, which light-guiding unit is adapted to receive the first light emitted by the first lighting unit and to project it out of the light-guiding unit onto the part of the surface surrounding the pedestal unit.

17. The device as claimed in claim 16, wherein the light-guiding unit is adapted to project the first light onto the part of the surface surrounding the pedestal unit at an angle between ±90°, in particular ±60° or ±40°, with respect to the longitudinal axis.

18. The device as claimed in claim 17, wherein the light-guiding unit has:
a light conductor, in particular a planar light conductor, which is adapted to receive the first light and to conduct it to a deflection mirror, in particular a curved deflection mirror, wherein the deflection mirror and the light conductor are adapted to project the first light onto the part of the surface surrounding the pedestal unit at an angle between ±90°, in particular ±60° or ±40°, with respect to the longitudinal axis.

19. A method for the low-glare illumination of a room, comprising the steps:
providing a translucent body;
providing a first lighting unit arranged on or in the translucent body;
lighting a surface with the first lighting unit;
providing a second lighting unit arranged in the translucent body, which second lighting unit is adapted to emit second light;
lighting the room with the second light through the translucent body.
